(19) United States
(12) Patent Application Publication
(10) Pub. No.: US 2026/0219516 A1
(43) Pub. Date: Jul. 30, 2026

(54) CONTACT LENS WITH NON-ORDERED SURFACE PILLARS

(71) Applicant: CooperVision International Limited, Fareham (GB)

(72) Inventors: Sourav SAHA, Pleasanton, CA (US); Matthew S. LINN, Castro Valley, CA (US); Tim WARREN, Dublin, CA (US); Lu JIANG, Pleasanton, CA (US)

(73) Assignee: CooperVision International Limited, Fareham (GB)

(21) Appl. No.: 19/145,546

(22) PCT Filed: Jan. 29, 2024
(86) PCT No.: PCT/GB2024/050219

§ 371 Date: Jul. 3, 2025

Related U.S. Application Data
(60) Provisional application No. 63/442,129, filed on Jan. 31, 2023.

(51) Int. Cl. G02C 7/04; B29D 11/00

(52) U.S. Cl. CPC G02C 7/049; B29D 11/00076; B29D 11/0048

(57) ABSTRACT

A contact lens having micropillars facilitate the spreading of liquid across the surface of the lens. The micropillars are present in at least the optic zone of the contact lens and are arranged to prevent diffraction of light through the optic zone.

### FIELD

The present invention relates to contact lenses having surface micropillars and to methods of making the same.

### BACKGROUND

A healthy tear film is important for ocular comfort. Contact lens wear disrupts the tear film into thinner pre- and post-lens tear films. A thin pre-lens tear film can break-up more quickly between blinks than the tear film of a non-lens wearer, which can expose the contact lens to surface air and cause lens dehydration which can in turn result in ocular discomfort. Additionally, a thin post-lens tear film can result in a reduced flow of nutrient-ladened tears to the cornea, which can adversely impact ocular health and/or lead to discomfort.

It would be desirable to provide contact lenses having front and/or back surfaces designed to improve the tear film quality of a lens wearer without negatively impacting the optical performance of the lens.

### SUMMARY

A feature of the present invention is to provide a contact lens that can facilitate the spreading of liquid across the surface of the lens.

An additional feature of the present invention is to provide a contact lens that facilitates the spreading of liquid across the surface of the lens while reducing undesirable light diffraction when the contact lens is being worn.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention, in part, relates to a contact lens. The contact lens includes an optic zone, a peripheral zone, and a circumferential edge. The contact lens includes a plurality of micropillars on a surface (anterior and/or posterior surface) in at least the optic zone. The pillars are preferably arranged in a non-ordered manner (wherein each of the pillars are not equally distanced apart from each other, or are pseudorandomized).

The present invention, in addition, relates to a contact lens that includes a plurality of micropillars present in at least the optic zone of the anterior surface or the posterior surface or both the anterior surface and posterior surface, wherein the micropillars present in the optic zone are non-ordered, and wherein the plurality of micropillars has a density of at least 10,000 micropillars/mm².

It is to be understood that both the foregoing general description and the following detailed description are exemplary and explanatory only and are intended to provide a further explanation of the present invention, as claimed.

The accompanying drawings, which are incorporated in and constitute a part of this application, illustrate some of the features of the present invention and together with the description, serve to explain the principles of the present invention.

### BRIEF DESCRIPTION OF THE DRAWINGS

FIG. 1 depicts the anterior and posterior surfaces of a contact lens.

FIG. 2 depicts the optic zone and peripheral zone of a contact lens.

FIGS. 3A-C, 4D-G, and 5H-K depict top and side views of various micropillar shapes.

FIG. 6 depicts micropillars ordered in different geometric patterns.

FIG. 7 depicts micropillars positioned randomly.

FIG. 8 depicts micropillars in a pseudorandom arrangement.

FIG. 9 is a graph that depicts the drop spreading characteristic of a silicone hydrogel with and without surface pillar structures.

### DETAILED DESCRIPTION

Contact lenses having a plurality of surface micropillars that facilitate the spreading of liquid, such as tears or eye drops, across the lens surface are described herein. The contact lens or lenses having the surface micropillars is at times referred to, herein, as a pillared contact lens or other similar terms. Methods of manufacturing the pillared contact lenses are further described herein. The plurality of micropillars may be present on the anterior (front) surface of the contact lens, the posterior (back) surface of the contact lens, or on both the anterior and posterior surfaces of the contact lens.

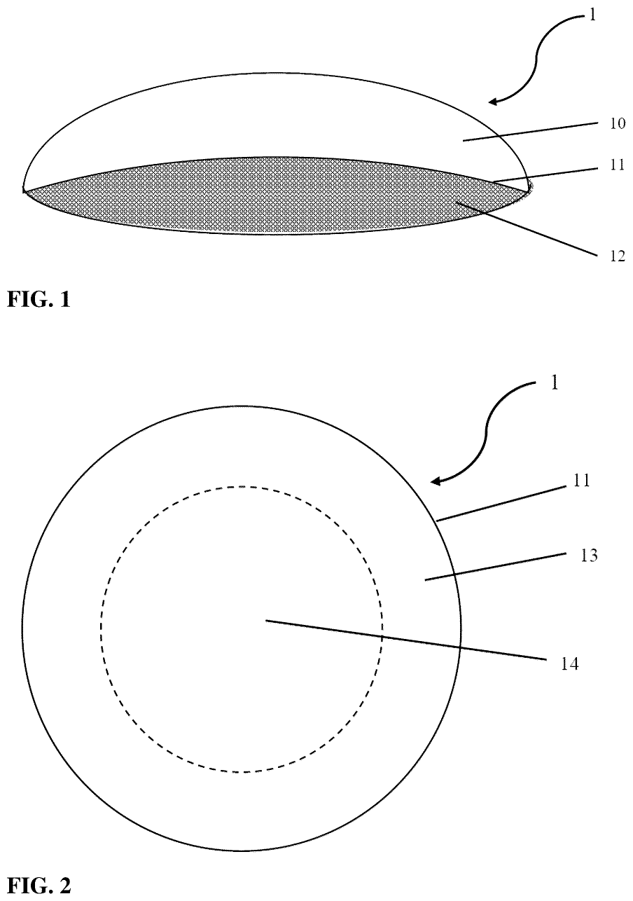

FIG. 1 depicts a perspective view of a contact lens, 1, comprising a concave posterior surface, 12, a convex anterior surface, 10, and a peripheral edge, 11. Referring to FIG. 2, which depicts a top view of a contact lens, 1, the contact lens additionally comprises an inner optic zone, 14, as defined by the dashed circle, and a peripheral zone, 13, which is depicted by the annulus region defined by the boundary of the optical zone and the peripheral edge, 11.

A conventional soft contact lens typically has a diameter of about 14 mm and an optic zone having a diameter of about 7 to 9 mm, such as about 8 mm. None of the figures herein depicting contact lenses, pillar shapes, or patterns or arrangements of pillars is to be construed as having been drawn to scale.

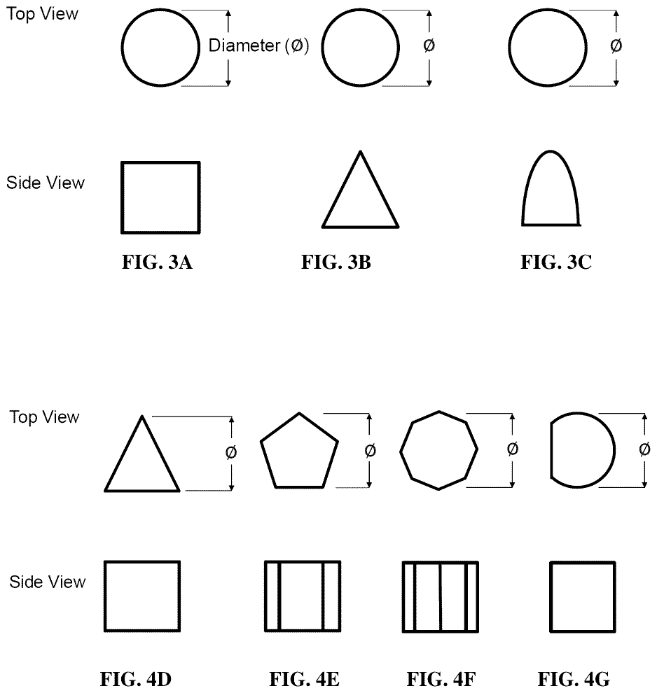

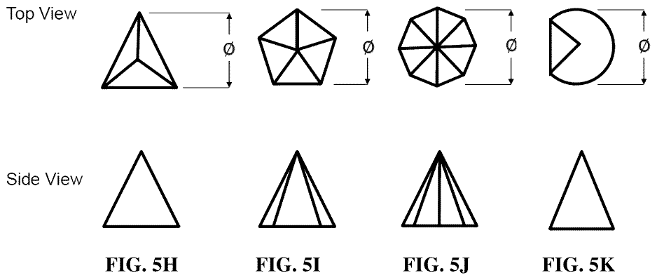

The contact lens of the invention includes a plurality of micropillars present on a surface (anterior surface and/or posterior surface) of the contact lens in at least the optic zone. The term pillar or micropillar refers to a 3-dimensional surface structure having a width and a height. FIGS. 3A to 5K depict non-limiting examples of a variety of pillar shapes that may be used with the contact lens of the invention. FIGS. 3A-C depict pillar shapes, A-C, that each have a circular base and a shape depicted by a side view: shape A depicts a cylindrical pillar, shape B depicts a conical pillar, and shape C depicts a parabolic pillar. FIGS. 4D-G depict pillar shapes, D-G, that each have a multi-sided base and a flat top. The pillars may have a geometrically-symmetrical shape with straight sides (e.g., shapes D-F), or they may have a geometrically-symmetrical shape with straight and curved sides (e.g., shape G). FIGS. 5H-K depict pillar shapes, H-K, that each have a multi-sided base (the same base shapes of pillars D-G, respectively, in FIGS. 4D-G) and that taper to a point, as opposed to having a flat top.

The height of a micropillar (i.e., micropillar height) is the perpendicular distance from the base of the pillar (i.e., in contact at the surface of the contact lens) to the opposing top of the pillar at the highest point of the pillar. The height of substantially every micropillar of the plurality may be from 0.1 μm to 2.0 μm, for instance. The micropillar height can be from 0.15 μm to 1.75 μm, from 0.2 μm to 1.5 μm, from 0.25 μm to 1.25 μm, or from 0.25 μm to 1.0 μm. The height can be same for each micropillar of the contact lens, or it can vary. For example, the contact lens can have a pillar height for each of the pillars that is the same or within 50% of each other pillar height present, such as within 45%, within 40%, within 35%, within 30%, within 30%, within 25%, within 20%, within 15%, within 10%, within 5%, within 1% of each other pillar height present.

The diameter of a micropillar, as defined herein, is the largest distance connecting any two points along the perimeter of the micropillar at 10% of its height from its base. FIGS. 4 and 5 (not to scale) show the diameters, Ø, of multi-sided micropillars. The micropillar diameter may be from 0.1 μm to 4.0 μm, for instance. The micropillar diameter can be from 0.2 μm to 3.0 μm, from 0.25 μm to 2.5 μm, or from 0.3 μm to 2.25 μm. The diameter can be same for each micropillar of the contact lens, or it can vary. For example, the contact lens can have a diameter for each of the micropillars that is the same or within 50% of each other micropillar diameter present, such as within 45%, within 40%, within 35%, within 30%, within 30%, within 25%, within 20%, within 15%, within 10%, within 5%, within 1% of each other micropillar diameter present. In one example, substantially every micropillar of the plurality has a diameter of from 0.1 μm to 4.0 μm. Throughout, the reference to “substantially” means at least 90% or at least 95% or at least 99% (by number) of all micropillars of the plurality.

The micropillar diameter and/or the micropillar height may be uniform relative to one another or may include a combination of more than one pillar diameter or more than one pillar height. For instance, the plurality of pillars may have two sets of pillars, one set that has a first pillar diameter and a second set that have a second pillar diameter. The average pillar diameter or average pillar height between the first set and second set can be any diameter or any height, for instance, as provided above. The average pillar diameter or average pillar height between the first set and second set can vary by at least 5%, at least 10%, at least 20%, at least 50%, such as from 5% to 200% or 5% to 100% or 10% to 75%. Further, as an option, the plurality of pillars can have more than two sets of pillars such as three or four or more with different average pillar diameters or average pillar heights. The arrangement of the pillars, when two or more sets of pillars are present, can be random, or arranged in any desired pattern (regions or sectors of each set, alternating, one annular zone of one set and a second annular zone of another set of pillars and so on). The pillars may include a bi-modal or multi-modal distribution of pillars in which the pillars include a combination of more than one type of pillar, each type having at least a different average pillar diameter and/or pillar height.

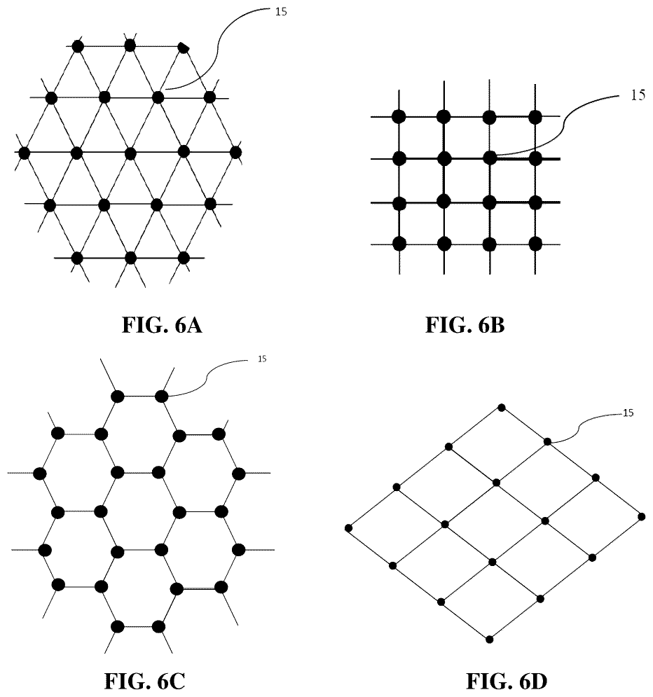

An ordered arrangement of micropillars may diffract light in the visible light spectrum thereby negatively impacting the optical performance of a pillared contact lens. Non-limiting examples of a variety of ordered arrangements are shown in FIGS. 6A-D, where each micropillar, 15, can be said to lie on a vertex of a multi-sided geometric shape and each pair of adjacent micropillars, each “micropillar pair”, can be said to form a side of the geometric shape. Pattern A (FIG. 6A) is based on an array of equilateral triangles, pattern B (FIG. 6B) is based on an array of squares, pattern C (FIG. 6C) is based on an array of hexagons, and pattern D (FIG. 6D) is based on an array of rhombuses. A pattern (or an arrangement of micropillars) is said to be “based on an array” of a certain multi-sided geometric shape when that shape can be pieced together (like a puzzle) to form a solid array of the geometric shape without gaps, as shown in FIG. 6A-D.

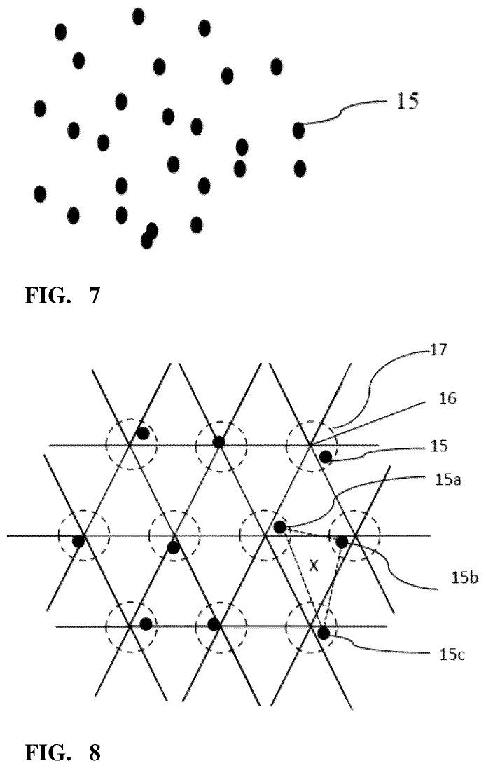

A contact lens having a non-ordered arrangement of micropillars in the optic zone can exhibit reduced diffraction of visible light through the optic zone compared to a control contact lens having an ordered arrangement of micropillars in the optic zone. A non-ordered arrangement may be one where the position of each micropillar in the optic zone is entirely random. FIG. 7 depicts one example of an entirely random arrangement of micropillars, 15. Notably there are no discernible geometric shapes or patterns formed by connecting adjacent micropillars. Alternatively, a non-ordered arrangement may be one where the location of each micropillar in the optic zone is positioned in a pseudorandom arrangement (as described further below).

Whether a pillared contact lens diffracts visible light may be qualitatively determined by passing a visible light laser through the lens using the method of Example 3. In Example 3 diffraction of red light at 635 nm is assessed. However, the method may be used to assess diffraction of visible light at other wavelengths in the visible spectrum. Thus, in various examples, the pillared contact lens has a non-ordered arrangement of micropillars within the optic zone and has reduced observable light diffraction at 405 nm, or at 520 nm, or at 635 nm, compared to a control contact lens.

A pseudorandom arrangement of a plurality of micropillars corresponds to an ordered arrangement of micropillars except that with the pseudorandom arrangement each micropillar is randomly placed within a defined radius about each point on which the corresponding micropillar of the ordered arrangement is placed. In one example, the contact lens has a plurality of micropillars in at least the optic zone that are in a pseudorandom arrangement based on an array of a multi-sided geometric pattern. As one such example, FIG. 8 depicts a pseudorandom arrangement of a plurality of micropillars based on an array of equilateral triangles. The dashed circle, 17, about each vertex, 16, of each equilateral triangle defined by the solid lines can be referred to as the perimeter of a “pillar zone”. Each pillar zone has a vertex as its center and is the same size as every other pillar zone in the pseudorandom arrangement. A single micropillar, 15, is randomly positioned within each pillar zone in the pseudorandom arrangement such that the geometric center of the base of each micropillar in a pillar zone of the pseudorandom arrangement is located at the center of the pillar zone (i.e., the vertex, 16), on the perimeter of the pillar zone, 17, or any point therebetween. A pseudorandom arrangement of a plurality of micropillars can be based on an array of other geometric shapes in the same way, i.e., where each micropillar of the plurality is positioned within a pillar zone, and where every pillar zone of the pseudorandom arrangement is centered on a vertex of the geometric shape and is the same size as every other pillar zone in the arrangement.

For purposes of determining whether there is reduced diffraction of visible light by a pillared contact lens having a non-ordered arrangement of micropillars in the optic zone, a control contact lens is used. The control contact lens is identical to the lens against which it is being compared (i.e., the “test lens”) except that the micropillars within the optic zone of the control contact lens are in an ordered arrangement. For a pillared contact lens having a pseudorandom arrangement of a plurality of micropillars, the control lens will have the ordered arrangement of micropillars upon which the pseudorandom arrangement is based. For example, if the pseudorandom arrangement of micropillars of FIG. 8 is based on the ordered arrangement of micropillars of pattern A (FIG. 6A), then the control lens will have its micropillars ordered in that pattern.

In the case where a pillared lens has an entirely random arrangement of micropillars in the optic zone, the control lens has the same total number of micropillars present in the optic zone as the test lens, with the micropillars in the optic zone being in an ordered arrangement based on an array of equilateral triangles. In this case, the length of the side of the triangle (i.e., the distance between each micropillar) will depend on the total number of micropillars in the optic zone.

A pseudorandom arrangement of a plurality of micropillars that is based on an array of a geometric shape can be characterized by the height and diameter of the micropillars (or average height and diameter of the micropillars if there is more than one size of micropillar in the plurality), the micropillar height to diameter (H/D) ratio (or average H/D ratio), and the average center-to-center (C-C) distance between the geometric centers of the base of each micropillar in each micropillar pair. Referring again to FIG. 8, a pair of micropillars of a pseudorandom arrangement of a plurality of micropillars based on an array of equilateral triangles will be the adjacent micropillars on each side of a triangle, such as micropillars 15a and 15b of triangle X in FIG. 8. Thus, each triangle of the array of triangles has 3 micropillar pairs. Similarly, each rectangle of an array of rectangles will have 4 micropillar pairs. References herein to an average C-C distance in a plurality of micropillars refers to the average C-C distance of all micropillar pairs in the array.

As an option, the contact lens of the present invention can have a pseudorandom arrangement of a plurality of micropillars in the optic zone where the average C-C distance of every micropillar pair in the arrangement is from 0.1 μm to 10 μm, such as from 0.2 μm to 9 μm, from 0.5 μm to 8 μm, or from 1 μm to 7 μm.

As an option, the contact lens of the present invention can have a pseudorandom arrangement of a plurality of micropillars in the optic zone where the average H/D ratio of the micropillars of the plurality is from 0.1 to 2, such as from 0.15 to 1.75, or from 0.2 to 1.5, or from 0.2 to 1.25, or from 0.25 to 1, or from 0.1 to 1.

Another parameter that can be used to characterize the arrangement of the plurality of micropillars is the ratio of the micropillar diameter to C-C distance (the D/CC ratio). The D/CC ratio between adjacent micropillars or the average D/CC ratio of all micropillar pairs will be less than 1. For example, the average D/CC ratio of a plurality of micropillars may be from about 0.1 to 0.9, or from about 0.15 to 0.75, or from about 0.15 to 0.6.

The number of micropillars present in a square millimeter (mm²) (the micropillar density) of the contact lens surface may be from about 10,000 to about 100,000,000 micropillars, such as from 10,000 to about 5,000,000 micropillars, or from 10,000 to 1,000,000 micropillars, or from 10,000 to 500,000 micropillars, or from 25,000 to 1,000,000 micropillars, or from 25,000 to 500,000 micropillars.

As mentioned herein, the surface micropillars are present in at least the optic zone of a surface of the contact lens. As an option, the surface micropillars can be additionally present in the peripheral zone of the same lens surface. When present, the arrangement of these surface micropillars in the peripheral zone can be ordered (i.e., an ordered pattern or array) or can be non-ordered as described herein for the optic zone. When a non-ordered pattern is used for the peripheral zone, the non-ordered pattern can be the same or different from the non-ordered pattern used in the optic zone. In one example the plurality of micropillars covers at least 70% of the anterior or posterior surface of the contact lens, such as at least 80%, at least 90%, or at least 99% of the anterior or posterior surface of the contact lens, or both the anterior and posterior surfaces of the contact lens. In one example the plurality of micropillars covers at least 90% of the anterior or posterior surface of the contact lens but does not extend all the way to the peripheral edge of the contact lens, such that there is an outer annulus of the surface of the contact lens that is smooth (i.e., is not pillared). Such outer annulus may have a width of less than 1 mm, such as a width of from about 0.01 mm to about 0.5 mm.

In some examples, the total number of micropillars on the anterior or posterior surface of the contact lens may from about 10⁵ to 10¹¹ micropillars, such as from about 6×10⁵ to 3×10¹⁰ micropillars.

When the plurality of micropillars is present on the anterior surface, improved wicking of liquid (e.g., tears) is achievable due to capillary forces. This phenomenon is known as hemi-wicking. Such hemi-wicking of a pre-lens surface of a contact lens could potentially help stabilization of a pre-lens tear film by quickly re-distributing pre-lens tear in the event of tear film evaporation drying the pre-lens surface during interblink cycle. The improvement in wicking of a pillared contact lens surface can be demonstrated by video capture analysis using the method described in Example 2. Briefly, a drop of liquid is dropped onto the pillared surface and using video capture system software a plot of the height of the drop on the surface versus time is generated. The drop height value (DHV) of the drop at 50 microseconds is compared between the pillared contact lens and a control contact lens, where the control contact lens is identical to the test lens to which it is being compared except that it has a smooth (i.e., non-pillared) surface. The pillared contact lens of the invention can have a DHV that is less than 80% that of a control lens, or less than 60% that of a control lens, or less than 50% that of a control lens. The pillared contact lens of the invention can have a DHV at 50 ms that is below 0.25, below 0.2, or below 0.15, such as from 0.24 to 0.12.

The surface of the contact lens that has the surface micropillars can be the posterior surface of the contact lens. When the posterior surface is utilized for the surface micropillars, post lens tear film thickness may be increased and improve wearer comfort.

The surface of the contact lens that has the surface micropillars can be both the posterior surface and anterior surface of the contact lens. In such an embodiment, the pillar parameters (dimensions, number, shape, and/or location-pattern) can be the same or different for each surface.

The contact lens of the present invention can be made from any lens material that is conventional in the art. The contact lens can be a hard or soft contact lens. Preferably, the contact lens is a hydrogel contact lens. The contact lens can preferably be made from or is a silicone hydrogel material.

A silicone hydrogel material is typically formed by curing a polymerizable composition (i.e., a monomer mixture) comprising at least one siloxane monomer and at least one hydrophilic monomer or at least one hydrophilic polymer, or a combination thereof. A “monomer” refers to a molecule comprising a polymerizable carbon-carbon double bond (i.e., a polymerizable group) capable of reacting with other polymerizable group-containing molecules that are the same or different, to form a polymer or copolymer. The term monomer encompasses polymerizable pre-polymers and macromers, there being no size constraint of the monomer unless indicated otherwise. The monomer may comprise a single polymerizable carbon-carbon double bond, or more than one polymerizable group, and thus have cross-linking functionality.

As used herein, the term “siloxane monomer” is a monomer that contains at least one Si—O group. Siloxane monomers useful in contact lens compositions are well-known in the art (see, e.g., U.S. Pat. Nos. 8,658,747 and 6,867,245). (All patents and publications mentioned here and throughout are incorporated in their entirety by reference.) In some examples, the polymerizable composition comprises a total amount of siloxane monomer of at least 10 wt. %, 20 wt. %, or 30 wt. % up to about 40 wt. %, 50 wt. %, 60 wt. %, or 70 wt. %. Unless specified otherwise, as used herein, a given weight percentage (wt. %) of a component of the polymerizable composition is relative to the total weight of all polymerizable ingredients and IPN polymers (as described further below) in the polymerizable composition. The weight of the polymerizable composition contributed by components, such as diluents, that do not incorporate into the final contact lens product are not included in the wt. % calculation.

In a specific example, the polymerizable composition comprises a hydrophilic vinyl monomer. As used-herein, a “hydrophilic vinyl monomer” is any siloxane-free (i.e., contains no Si—O groups) hydrophilic monomer having a polymerizable carbon-carbon double bond (i.e., a vinyl group) present in its molecular structure that is not part of an acryl group, where the carbon-carbon double bond of the vinyl group is less reactive than the carbon-carbon double bond present in a polymerizable methacrylate group under free radical polymerization. As used herein, the term “acryl group” refers to the polymerizable group present in acrylate, methacrylates, acrylamides, etc. Thus, while carbon-carbon double bonds are present in acrylate and methacrylate groups, as used herein, such polymerizable groups are not considered to be vinyl groups. Further, as used herein, a monomer is “hydrophilic” if at least 50 grams of the monomer are fully soluble in 1 liter of water at 20° C. (i.e., ~ 5% soluble in water) as determined visibly using a standard shake flask method.

In various examples, the hydrophilic vinyl monomer is N-vinyl-N-methylacetamide (VMA), or N-vinyl pyrrolidone (NVP), or 1,4-butanediol vinyl ether (BVE), or ethylene glycol vinyl ether (EGVE), or diethylene glycol vinyl ether (DEGVE), or any combination thereof. In one example, the polymerizable composition comprises at least 10 wt. %, 15 wt. %, 20 wt. %, or 25 wt. % up to about 45 wt. %, 60 wt. %, or 75 wt. % of a hydrophilic vinyl monomer. As used herein, a given weight percentage of a particular class of component (e.g., hydrophilic vinyl monomer, siloxane monomer, or the like) in the polymerizable composition equals the sum of the wt. % of each ingredient in the composition that falls within the class. Thus, for example, a polymerizable composition that comprises 5 wt. % BVE and 25 wt. % NVP and no other hydrophilic vinyl monomer, is said to comprise 30 wt. % hydrophilic vinyl monomer. In a specific example, the polymerizable composition comprises from about 25 wt. % up to about 75 wt. % of VMA or NVP, or a combination thereof. Additional hydrophilic monomers that may be included in the polymerizable composition are N,N-dimethylacrylamide (DMA), 2-hydroxyethyl methacrylate (HEMA), ethoxyethyl methacrylamide (EOEMA), ethylene glycol methyl ether methacrylate (EGMA), and combinations thereof.

A specific example of a hydrogel contact lens of the present invention is one that is based on a polymerizable composition comprising from 25 wt. % to 55 wt. % of siloxane monomer(s) or macromer(s), from 30 wt. % to 55 wt. % of a vinyl monomer selected from NVP, VMA, or combinations thereof, and optionally from about 1 wt. % to about 20 wt. % of a hydrophilic monomer selected from N,N-dimethylacrylamide (DMA), 2-hydroxyethyl methacrylate (HEMA), ethoxyethyl methacrylamide (EOEMA), or ethylene glycol methyl ether methacrylate (EGMA), or any combination thereof, and optionally from about 1 wt. % to about 20 wt. % of a hydrophobic monomer selected from methyl methacrylate (MMA), isobornyl methacrylate (IBM), or 2-hydroxybutyl methacrylate (HOB) or any combination thereof. Silicone hydrogel materials made from this specific embodiment of polymerizable composition include stenfilcon A, comfilcon A, somofilcon A, fanfilcon A, and enfilcon A. In a further example, the above-described polymerizable composition comprises the siloxanes of stenfilcon A, specifically a first siloxane having the structure represented by Formula (II),

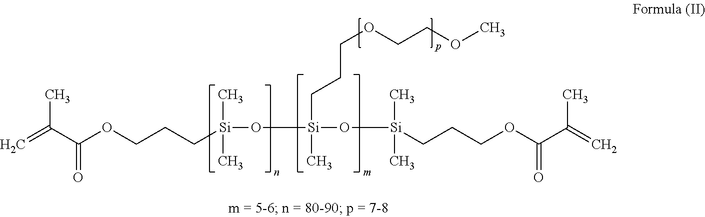

and a second siloxane having the structure represented by Formula (III),

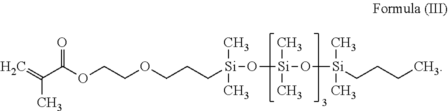

The polymerizable composition may additionally comprise at least one cross-linking agent. As used herein, a “cross-linking agent” is a monomer having at least two polymerizable groups. Thus, a cross-linking agent can react with functional groups on two or more polymer chains so as to bridge one polymer to another. The cross-linking agent may comprise an acryl group or a vinyl group, or both an acryl group and a vinyl group. In certain examples, the cross-linking agent is free of siloxane moieties, i.e., it is a non-siloxane cross-linking agent. A variety of cross-linking agents suitable for use in silicone hydrogel polymerizable compositions are known in the field (see, e.g., U.S. Pat. No. 8,231,218, incorporated herein by reference). Examples of suitable cross-linking agents include, without limitation, lower alkylene glycol di(meth)acrylates such as triethylene glycol dimethacrylate and diethylene glycol dimethacrylate; poly(lower alkylene) glycol di(meth)acrylates; lower alkylene di(meth)acrylates; divinyl ethers such as triethyleneglycol divinyl ether, diethyleneglycol divinyl ether, 1,4-butanediol divinyl ether and 1,4-cyclohexanedimethanol divinyl ether; divinyl sulfone; di- and trivinylbenzene; trimethylolpropane tri(meth)acrylate; pentaerythritol tetra(meth)acrylate; bisphenol A di(meth)acrylate; methylenebis(meth)acrylamide; triallyl phthalate; 1,3-Bis(3-methacryloxypropyl)tetramethyldisiloxane; diallyl phthalate; and combinations thereof.

As will be appreciated by those skilled in the art, the polymerizable composition may comprise additional polymerizable or non-polymerizable ingredients conventionally used in contact lens formulations such as one or more of a polymerization initiator, a UV absorbing agent, a tinting agent, an oxygen scavenger, a chain transfer agent, or the like. In some examples, the polymerizable composition may include an organic diluent in an amount to prevent or minimize phase separation between the hydrophilic and hydrophobic components of the polymerizable composition, so that an optically clear lens is obtained. Diluents commonly used in contact lens formulations include hexanol, ethanol, and/or other alcohols. In other examples, the polymerizable composition is free or substantially free (e.g., less than 500 ppm) of an organic diluent. In such examples, the use of siloxane monomers containing hydrophilic moieties such as polyethylene oxide groups, pendant hydroxyl groups, or other hydrophilic groups, may make it unnecessary to include a diluent in the polymerizable composition. Non-limiting examples of these and additional ingredients that may be included in the polymerizable composition are provided in U.S. Pat. No. 8,231,218.

Non-limiting examples of other silicone hydrogel materials that may be used to form a pillared contact lens of the invention include senofilcon A, senofilcon C, narafilcon A, delefilcon A, narafilcon A, lotrafilcon A, lotrafilcon B, balafilcon A, samfilcon A, galyfilcon A, and asmofilcon A.

As stated, in preferred embodiments, the contact lens of the present invention can be considered a soft contact lens, and particularly a soft silicone hydrogel contact lens.

As part of the present invention, the contact lens can be sealed in a contact lens package. The packaging solution sealed within the contact lens package may be any conventional contact-lens compatible solution. In one example, the packaging solution comprises, consists, or consists essentially, of an aqueous solution of a buffer, and/or a tonicity agent. In another example, the packaging solution contains additional agents such as one or more additional antimicrobial agents, and/or a comfort agent, and/or a hydrophilic polymer, and/or a surfactant and/or other beneficial agent. In some examples, the packaging solution may comprise polysaccharides (e.g., hyaluronic acid, hydroxypropyl methylcellulose, hydroxypropyl cellulose, hydroxyethyl cellulose, etc.) or other high molecular weight polymers, such as polyvinyl pyrrolidone, which are commonly used as comfort polymers or thickening agents in ophthalmic solutions and contact lens packaging solutions. In other examples, the packaging solution may comprise an ophthalmic drug. The packaging solution can have a pH in the range of about 6.8 or 7.0 up to about 7.8 or 8.0. In one example, the packaging solution comprises phosphate buffer or borate buffer. In another example, the packaging solution comprises a tonicity agent selected from sodium chloride or sorbitol in an amount to maintain osmolality in the range of about 200 to 400 mOsm/kg, and typically from about 270 mOsm/kg up to about 310 mOsm/kg.

With respect to the contact lens package, this package can include or comprise a plastic base member comprising a cavity configured to retain the contact lens and packaging solution and a flange region extending outwardly around the cavity. A removable foil is attached to the flange region to provide a sealed contact lens package. Such contact lens packages, which are commonly referred to as “blister packs”, are well-known in the art (see e.g., U.S. Pat. No. 7,426,993).

It will be appreciated that conventional manufacturing methods can be used to manufacture the sealed contact lens package. In a method of manufacturing a contact lens package, the method can include the step of placing an unworn contact lens and a contact lens packaging solution in a receptacle, placing a cover on the receptacle, and sealing the cover on the receptacle. Generally, the receptacle is configured to receive a single contact lens and an amount of packaging solution sufficient to completely cover the contact lens, typically about 0.5-1.5 ml. The receptacle may be made from any suitable material, such as glass or plastic. In one example, the receptacle comprises a plastic base member comprising a cavity configured to retain the contact lens and packaging solution and a flange region extending outwardly around the cavity, and the cover comprises a removable foil attached to the flange region to provide the sealed contact lens package. The removable foil may be sealed by any conventional means such as heat sealing or gluing. In another example, the receptacle is in the form of a plastic base member comprising a plurality of threads and the cover comprises a plastic cap member comprising a compatible set of thread for engagement with the threads of the base member thereby providing a resealable cover. It will be appreciated that other types of packaging can also be used to provide a resealable package. For example, the contact lens package may comprise a plastic cover comprising features that engage with compatible features of the receptacle to form an interference fit. The method of manufacturing the sealed contact lens package may further comprise sterilizing the unworn contact lens by autoclaving the sealed contact lens package. Autoclaving generally involves subjecting the sealed contact lens package to temperatures of at least 121° C. for at least 20 minutes.

The contact lens can be provided unworn (i.e., a new contact lens, not having been previously used by a patient), immersed in the packaging solution and sealed in a package. The package may be a blister package, glass vial, or other appropriate container. The package comprises a base member having a cavity for accommodating a packaging solution and an unworn contact lens. The sealed package may be sterilized by sterilizing amounts of radiation, including heat or steam, such as by autoclaving, or by gamma radiation, e-beam radiation, ultraviolet radiation, etc.

In a specific example, the packaged contact lens is sterilized by autoclaving.

The final product can be a sterile, packaged contact lens (e.g., silicone hydrogel contact lens) having ophthalmically-acceptable surface wettability.

In addition, the present invention relates to a mold insert for forming a mold for cast molding a pillared contact lens. The mold insert (also known as a master mold or mold tool) is formed from metal (e.g., steel) in a conventional manner. The micropillars are then formed on the mold insert using nano/micro patterning techniques, such as, but not limited to, laser micro machining, nano/micro imprinting, nano/micro deposition, or nano/micro etching methods. In making the pillared contact lens of the present invention, the mold insert is used to mold a mold member, such as by cast molding or injection molding. Typically, a thermoplastic material is used to form the mold member, such as, but not limited to, polypropylene, ethylene vinyl alcohol, polyethylene terephthalate, and the like. In the case where the posterior surface of the pillared contact lens is the surface having the micropillar pattern, the micropillars are formed on the mold insert used to form the male mold member. In the case where the anterior surface of the pillared contact lens is the surface having the micropillars, the micropillars are formed on the mold insert used to form the female mold member.

As can be appreciated, the surface of the mold member to provide the pillar pattern to the contact lens has the negative pattern of the pillar pattern present on the mold insert. The negative pattern of each micropillar on the mold member is referred to herein as a “dimple”. If the anterior side of the lens has no pillars, a conventional female mold insert can be used to form the female mold member. If the posterior side of the lens has no pillars, a conventional male mold insert can be used to form the male mold member. In some examples, a mold member can be formed without any dimples and thereafter the dimples can be added to the mold member, such as by imprinting or other suitable method.

A polymerizable composition is dispensed into a female mold member having a concave surface that defines the anterior surface of the contact lens. The male mold member having a convex surface that defines the posterior surface of the contact lens is combined with the female mold member to form a contact lens mold that is subjected to curing conditions, such as UV or thermal curing conditions, under which the curable composition is formed into a polymeric lens body. The mold is disassembled (i.e., demolded) and the polymeric lens body is removed from the mold and contacted with an organic solvent, such as ethanol, to extract unreacted components from the lens body. After extraction, the lens body is hydrated in an aqueous solution. Exemplary methods of manufacturing silicone hydrogel contact lenses are described in U.S. Pat. No. 8,865,789.

The following Examples illustrate certain aspects and advantages of the present invention, which should be understood not to be limited thereby

### Example 1. Preparation of Silicone Hydrogel Having Surface Micopillars

Stenfilcon A monomer mixture was dispensed onto flat (i.e., non-curved) polypropylene discs having the inverse of the pillar dimensions listed in Table 1, which were positioned in an ordered pattern based on an equilateral triangle as depicted in pattern A (FIG. 6A). A polypropylene disk having a smooth, un-patterned surface was placed on top of the dispensed monomer mixture. The top and bottom disks with the monomer mixture sandwiched therebetween, were secured together to form a mold assembly which was placed in a curing oven. For the control sample, both the top and bottom disks were smooth.

After the samples were cured, the top mold piece for each sample was slowly twisted off the cured stenfilcon A. The cured stenfilcon A disks were submerged into a mixture of 50/50 EtOH/DI water to swell and release them from the bottom mold pieces. The stenfilcon A disks were hydrated in DI water, transferred to 6 mL vials containing 4 mL DI water and autoclaved.

### Example 2. Hemi-Wicking Behavior of Silicone Hydrogel Having Surface Micropillars

A video capture system was used to analyze drop spreading on stenfilcon A disks prepared in Example 1. The tip of a drop dispensing needle was positioned 10 mm above the center of the pillared side of each sample. A 5.5 μl drop of water was dropped onto the center of the sample and the spreading of the droplet onto the surface was captured by video (1000 fps). Video capture system software generated plots showing the height of the drop on the surface of the stenfilcon A disc versus time elapse. The drop spreading data represents hemi-wicking surface behavior by both depicting suppression of oscillation behavior and reduction in drop peak height. The height of the droplet on the surface is measured as a fraction of the diameter of the spherical droplet before it touches the surface. This nondimensional drop height is used instead of absolute drop height to make the data independent of the liquid drop volume used for the measurement.

Steady state (SS) drop height of the patterned surfaces is reached within 50 ms. Non-dimensional drop height values (DHV) at 50 ms are provided in Table 1 where Ht. is the pillar height, Diam. is the pillar diameter, H/D ratio is the ratio of the pillar height to diameter, and CC Dist. is the center-to-center distance between adjacent pillars. The micropillar dimensions provided in Table 1 are the dimensions of the micropillars before the discs were hydrated. Given the % swell of the disc material, the height and diameter of the micropillars of the hydrated discs were about 20% higher than the values of Table 1.

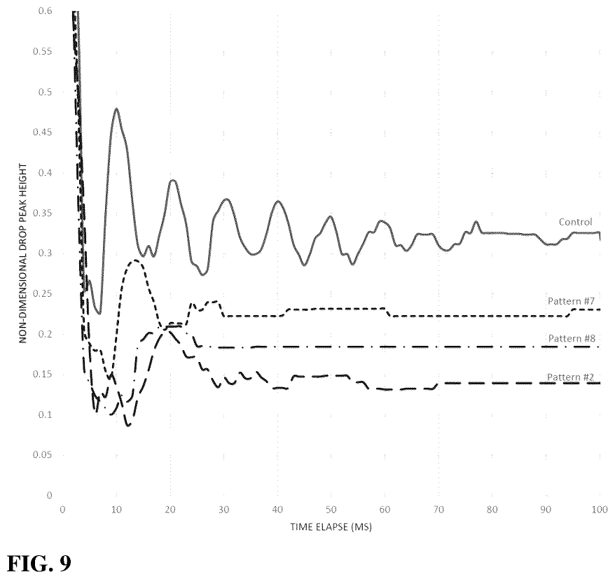

A plot showing the drop spreading characteristic of a flat stenfilcon A disc (control) compared to patterned stenfilcon A disks is depicted in FIG. 9.

TABLE 1

| | | | | CC | | % of |
|---|---|---|---|---|---|---|
| Pattern | Ht. | Diam. | H/D | Dist. | DHV at | Ctrl |
| No. | (μm) | (μm) | Ratio | (μm) | 50 ms | DHV |
| Control | / | / | / | / | 0.345 | |
| 1 | 0.25 | 0.5 | 0.5 | 2 | 0.258 | 75 |
| 2 | 0.5 | 1 | 0.5 | 2 | 0.148 | 43 |
| 3 | 0.5 | 1 | 0.5 | 4 | 0.152 | 44 |
| 4 | 0.5 | 0.5 | 1 | 2 | 0.285 | 83 |
| 5 | 0.5 | 0.5 | 1 | 3 | 0.22 | 64 |
| 6 | 0.5 | 2 | 0.25 | 4 | 0.194 | 56 |
| 7 | 0.5 | 2 | 0.25 | 6 | 0.231 | 67 |
| 8 | 0.9 | 0.9 | 1 | 2 | 0.184 | 53 |
| 9 | 1 | 1 | 1 | 4 | 0.179 | 52 |
| 10 | 1 | 2 | 0.5 | 4 | 0.127 | 37 |
| 11 | 1 | 2 | 0.5 | 6 | 0.177 | 51 |

### Example 3

Light diffraction from the pillared surfaces of the stenfilcon A disks prepared in Example 1 was qualitatively evaluated. Briefly, each hydrated stenfilcon A disk was placed in a quartz disk to stabilize the silicone hydrogel sample against an optically smooth flat surface. The side of the pillar structures on the sample, whether facing the quartz disk or not, did not impact the diffraction pattern. Each sample/quartz disk was placed inside a quartz cuvette. The cuvette was then filled with DI water to fully submerge the sample. A red laser (Thorlabs, PL204, 635 nm, 0.9 mW) was used to shine red light through the sample to get the diffraction on a post mountable viewing screen (Thorlabs, EDU-VS1/M) placed approximately 8 cm. from the cuvette. The screen was placed in the dark by surrounding it by a cardboard box so that weak diffraction signals could be spotted. Pattern numbers 2, 3, 6-8, 10, and 11 of Table I exhibited strong diffraction and the remaining patterns exhibited relatively weak diffraction. A reduction in diffraction of visible light is achieved by a pseudorandom arrangement of the patterns such that the average C-C distance for each pattern is the same as the corresponding ordered arrangement.

The disclosure herein refers to certain illustrated examples, it is to be understood that these examples are presented by way of example and not by way of limitation. The intent of the foregoing detailed description, although discussing exemplary examples, is to be construed to cover all modifications, alternatives, and equivalents of the examples as may fall within the spirit and scope of the invention as defined by the additional disclosure.

References herein to “an example” or “a specific example” or “an aspect” or “an embodiment” or similar phrase, are intended to introduce a feature or features of the contact lens with surface pillars or components thereof, the sealed contact lens package or components thereof, or method of manufacturing the contact lens with surface pillars (depending on context) that can be combined with any combination of previously-described or subsequently-described examples, aspects, embodiments (i.e. features), unless a particular combination of features is mutually exclusive, or if context indicates otherwise. Further, as used in this specification, the singular forms “a,” “an,” and “the” include plural referents (e.g., at least one or more) unless the context clearly dictates otherwise. Thus, for example, reference to a “contact lens” includes a single lens as well as two or more of the same or different lenses.

The entire contents of all cited references in this disclosure, to the extent that they are not inconsistent with the present disclosure, are incorporated herein by reference.

The present invention can include any combination of the various features or embodiments described above and/or in the claims below as set forth in sentences and/or paragraphs. Any combination of disclosed features herein is considered part of the present invention and no limitation is intended with respect to combinable features.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

The present invention includes the following aspects/embodiments/features in any order and/or in any combination:
1. A contact lens comprising an optic zone, a peripheral zone, an anterior surface, and a posterior surface, said contact lens comprising a plurality of micropillars present in at least the optic zone of the anterior surface or the posterior surface or both the anterior surface and posterior surface, wherein the micropillars present in the optic zone are in a pseudorandom arrangement.
2. The contact lens of any preceding or following embodiment/feature/aspect, wherein the pseudorandom arrangement is based on an array of a multi-sided geometric shape.
3. The contact lens of any preceding or following embodiment/feature/aspect, wherein the pseudorandom arrangement is based on an array of equilateral triangles or an array of squares, or an array of hexagons, or an array of rhombuses.
4. The contact lens of any preceding or following embodiment/feature/aspect, wherein at least some of the micropillars are present in the peripheral zone.
5. The contact lens of any preceding or following embodiment/feature/aspect, wherein the plurality of micropillars has a density of 10,000 to 100,000,000 micropillars per square millimeter, or from 25,000 to 1,000,000 micropillars per square millimeter, or from 25,000 to 500,000 micropillars per square millimeter.
6. The contact lens of any preceding or following embodiment/feature/aspect, wherein the total number of micropillars on the anterior or posterior surface of the contact lens is from about 10⁵ to 10¹¹, or from about 6×10⁵ to 3×10¹⁰.
7. The contact lens of any preceding or following embodiment/feature/aspect, wherein the plurality of micropillars has an average C-C distance from 0.1 μm to 10 μm, or from 0.2 μm to 9 μm, or from 0.5 μm to 8 μm, or from 1 μm to 7 μm.
8. The contact lens of any preceding or following embodiment/feature/aspect, wherein substantially every micropillar of the plurality has a height of from 0.1 μm to 2.0 μm, or from 0.15 μm to 1.75 μm, or from 0.2 μm to 1.5 μm, or from 0.25 μm to 1.25 μm, or from 0.25 μm to 1.0 μm.
9. The contact lens of any preceding or following embodiment/feature/aspect, wherein substantially every micropillar of the plurality has a diameter of from 0.1 μm to 4.0 μm, or from 0.2 μm to 3.0 μm, or from 0.25 μm to 2.5 μm, or from 0.3 μm to 2.25 μm.
10. The contact lens of any preceding or following embodiment/feature/aspect, wherein the micropillars have an average height to diameter (H/D) ratio of 0.1 to 2, or from 0.15 to 1.75, or from 0.2 to 1.5, or from 0.2 to 1.25, or from 0.25 to 1, or from 0.1 to 1.
11. The contact lens of any preceding or following embodiment/feature/aspect, wherein the contact lens is a hydrogel contact lens.
12. The contact lens of any preceding or following embodiment/feature/aspect, wherein the contact lens is a silicone hydrogel contact lens.
13. The contact lens of any preceding or following embodiment/feature/aspect, wherein the contact lens exhibits a reduction in observable light diffraction at a wavelength between 400 nm to 700 nm compared to a control contact lens having an ordered arrangement of micropillars.
14 The contact lens of any preceding or following embodiment/feature/aspect, wherein the wavelength is 635 nm.
15. The contact lens of any preceding or following embodiment/feature/aspect, wherein the plurality of micropillars is in the optic zone of the anterior surface.
16. The contact lens of any preceding or following embodiment/feature/aspect, wherein the micropillars in the peripheral zone are in an ordered configuration.
17. The contact lens of any preceding or following embodiment/feature/aspect, wherein the micropillars result in a steady-state non-dimensional drop height value (DHV) at 50 ms that is less than 80% that of a control lens having a smooth surface.
18. The contact lens of any preceding or following embodiment/feature/aspect, wherein the micropillars result in a steady-state non-dimensional drop height value (DHV) at 50 ms that is less than 60% that of a control lens having a smooth surface.
19. Further aspects/embodiments/features include a mold member for cast molding a plurality of micropillars on a surface of a contact lens comprising an optic zone, wherein the plurality of micropillars is in the optic zone in a pseudorandom arrangement.
20. Further aspects/embodiments/features include a molding insert for forming the mold member of any preceding or following embodiment/feature/aspect.
21 Further aspects/embodiments/features include a contact lens comprising an optic zone, a peripheral zone, an anterior surface, and a posterior surface, said contact lens comprising a plurality of micropillars present in at least the optic zone of the anterior surface or the posterior surface or both the anterior surface and posterior surface, wherein the micropillars present in the optic zone are non-ordered, and wherein the plurality of micropillars has a density of at least 10,000 micropillars/mm².

The present invention can include any combination of these various features or embodiments above and/or below as set forth in sentences and/or paragraphs. Any combination of disclosed features herein is considered part of the present invention and no limitation is intended with respect to combinable features.

The disclosure herein refers to certain illustrated examples, it is to be understood that these examples are presented by way of example and not by way of limitation. The intent of the foregoing detailed description, although discussing exemplary examples, is to be construed to cover all modifications, alternatives, and equivalents of the examples as may fall within the spirit and scope of the invention as defined by the additional disclosure.

The entire contents of all cited references in this disclosure, to the extent that they are not inconsistent with the present disclosure, are incorporated herein by reference.

The present invention can include any combination of the various features or embodiments described above and/or in the claims below as set forth in sentences and/or paragraphs. Any combination of disclosed features herein is considered part of the present invention and no limitation is intended with respect to combinable features.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1-21. (canceled)

22. A contact lens comprising an optic zone, a peripheral zone, an anterior surface, and a posterior surface, said contact lens comprising a plurality of micropillars present in at least the optic zone of the anterior surface or the posterior surface or both the anterior surface and posterior surface,
wherein the micropillars present in the optic zone are in a pseudorandom arrangement based on an array of a multi-sided geometric shape, wherein the contact lens exhibits a reduction in observable light diffraction at a wavelength between 400 nm to 700 nm compared to a control contact lens having the ordered arrangement of micropillars upon which the pseudorandom arrangement is based where each micropillar of the control lens can be said to lie on a vertex of a multi-sided geometric shape and each pair of adjacent micropillars can be said to form a side of the geometric shape,
and wherein the plurality of micropillars has a density of 10,000 to 100,000,000 micropillars/mm².

23. The contact lens of claim 22, wherein the pseudorandom arrangement is based on an array of equilateral triangles.

24. The contact lens of claim 22, wherein the wavelength is 635 nm.

25. The contact lens of claim 22, comprising a plurality of micropillars present in at least the optic zone of the anterior surface.

26. The contact lens of claim 22, wherein at least some of the micropillars are present in the peripheral zone.

27. The contact lens of claim 22, wherein the plurality of micropillars has a density of 25,000 to 1,000,000 micropillars per square millimeter.

28. The contact lens of claim 22, wherein the total number of micropillars on the anterior or posterior surface of the contact lens is from about 10⁵ to 10¹¹.

29. The contact lens of claim 23, wherein the plurality of micropillars has an average center-to-center (C-C) distance from 0.1 μm to 10 μm.

30. The contact lens of claim 22, wherein substantially every micropillar of the plurality of micropillars has a height of from 0.1 μm to 2.0 μm.

31. The contact lens of claim 22, wherein substantially every micropillar of the plurality of micropillars has a diameter of from 0.1 μm to 4.0 μm.

32. The contact lens of claim 22, wherein the micropillars have an average height to diameter (H/D) ratio of 0.1 to 2.

33. The contact lens of claim 26, wherein the micropillars in the peripheral zone are in an ordered configuration.

34. The contact lens of claim 22, wherein the micropillars result in a steady-state non-dimensional drop height value (DHV) at 50 ms that is less than 80% that of a control lens having a smooth surface.

35. The contact lens of claim 22, wherein the micropillars result in a steady-state non-dimensional drop height value (DHV) at 50 ms that is less than 60% that of a control lens having a smooth surface.

36. The contact lens of claim 22, wherein the contact lens is a hydrogel contact lens.

37. The contact lens of claim 36, wherein the hydrogel contact lens is a silicone hydrogel contact lens.

38. A mold member for cast molding the contact lens of claim 22.

39. A molding insert for forming the mold member of claim 38.
